(19) United States
(12) Patent Application Publication
(10) Pub. No.: US 2004/0182641 A1
(43) Pub. Date: Sep. 23, 2004

(54) Underwater vocal communication device and method for communicating underwater

(75) Inventor: Jermey Lee Overmyer, Scottsdale, AZ (US)

Correspondence Address: JERMEY LEE OVERMYER, 7801 EAST BEATRICE STREET, SCOTTSDALE, AZ, 85257, US

(73) Assignee: Mr. Jermey Overmyer, Scottsdale, AZ (US)

(21) Appl. No.: 10/249,126

(22) Filed: Mar. 18, 2003

(51) Int. Cl. G10K 11/00

(52) U.S. Cl. 181/21; 181/22

(57) ABSTRACT

A communication device used to talk underwater. The device allows a speaker to fill a mouthpiece (22) with air while underwater and immediately begin speech thus allowing the speaker to start talking underwater with a minimal amount of air expended and not having to fill the device with air before going underwater. The mouthpiece (22) surrounds the mouth and creates an airtight seal between the device and the skin surrounding the mouth (20). Connected to the mouthpiece (22) is an air chamber (23) that is shaped to substantially minimize the amount of acoustic energy, or sound, being reflected back into the speaker's mouth through the mouthpiece (22). At the bottom of the air chamber (23) is a venting area (24) with small perforations to allow the air to escape the device in small and relatively quiet bubbles.

### CROSS REFERENCE TO RELATED APPLICATIONS

Stachowski U.S. Pat. No. 5,877,460 Mar. 2, 1999; Anderson U.S. Pat. No. 5,493,079 Feb. 20, 1996; Payne U.S. Pat. No. 4,527,657 Jul. 9, 1985; Williams U.S. Pat. No. 4,183,422 Jan. 15, 1980; Payne U.S. Pat. No. 4,071,110 Jan. 31, 1978; Alexander U.S. Pat. No. 3,828,887 Aug. 13,1974; Alexander U.S. Pat. No. 3,548,371 Dec. 15, 1970

### BACKGROUND OF INVENTION

This invention relates generally to underwater vocal communication devices, and specifically, to simple, low-cost, non-electronic devices allowing a human speaker to talk underwater and be heard by another human listener.

Many types of underwater vocal communication devices are available now, however only electronic devices are readily available. Electronic devices of this nature are expensive and most require at least two sets of the same equipment in order to be used. Electronic devices also require great care to keep them from getting wet. No simple, durable, and non-electronic device currently available allows a speaker to communicate at any depth, effectively transmits acoustic energy (sound) from air to water, and does not need to be filled full of air before being submerged.

Stachowski's U.S. Pat. No. 5,877,460 discloses a non-electronic underwater vocal communication device that is for diving, snorkeling, and swimmers. This device requires the speaker to prepare the device by filling it full of air before submersing. This device requires the speaker to plan on using the device before going underwater because the device has to be prepared prior to going underwater. If any water enters into the device there is no way to expel the water completely without returning to the surface. The buoyancy of the large volume of air required to use the device makes the device difficult to submerse. This device is cone shaped with a diaphragm at the large end that directly reflects the majority of the acoustic energy back into the mouth. Because of this, only a small percentage of the acoustic energy is transmitted into the surrounding water.

Anderson's U.S. Pat. No. 5,493,079 discloses a non-electronic underwater vocal communication device that is also a snorkel. Part of this device is held inside the mouth and the device therefore muffles the sound. This device has a set of rubber lips to make plosive sounds requiring the speaker to learn to speak in an altered manner. This device is designed to work only in very close proximity to the surface while breathing through the snorkel.

Payne's U.S. Pat. No. 4,527,657 discloses a non-electronic underwater vocal communication device that is designed specifically for scuba diving. This device is designed to be used in conjunction with a bubble silencer disclosed in Payne's U.S. Pat. No. 4,527,658. This silencer is slipped around the head. This device is too large and cumbersome to be used frequently except in conjunction with scuba gear. This device utilizes a reversed horn shape to facilitate multiple reflections of the acoustic energy, and uses a material that matches the acoustic impedance of water. However, due to the shape of the device the majority of the acoustic energy is reflected directly back into the mouth of the diver so that only a small percentage of the acoustic energy is actually transmitted into the surrounding water.

Williams' U.S. Pat. No. 4,183,422 discloses a non-electronic underwater vocal communication device and uses an inflatable balloon that the speaker must inflate before and during speech. This device requires the use of both hands to operate, one hand to hold the device to the face, and the other hand to hold the balloon part of the device down against the rising pressure of the trapped air. This device requires extra effort above talking just to inflate the balloon underwater. Because of the nature of this device it needs to be filled two thirds full of air to adequately transmit voice. This device is also easily breakable due to the possibility of puncturing the balloon part of the device. Because this device employs the rebreathing of air, there is a danger of the balloon being punctured during inhalation, which would be hazardous.

Payne's U.S. Pat. No. 4,071,110 discloses a non-electronic underwater vocal communication device that is designed specifically for scuba diving. This device requires the diver to hold in the diver's mouth a bit that muffles the sound and impedes articulation. This device also does not solve the problem of the noise made by the bubbles produced by normal use of scuba gear. This device uses a multiple-part mechanism to match acoustic energy with the surrounding water. This device is complicated and has many parts making the device less durable and reliable. This device uses a diaphragm to transmit the acoustic energy to the surrounding water. However, this diaphragm directly reflects the majority of the acoustic energy back into the mouth and in so doing loses a large majority of the acoustic energy. This device can only be used in conjunction with scuba gear.

Alexander's U.S. Pat. No. 3,828,887 discloses a non-electronic underwater vocal communication device that can be used underwater without any other devices. This device is bulky and is made to come apart into two pieces when not in operation. This device requires the speaker to completely fill an air chamber with air before speaking, thus limiting the amount of air left in the divers lungs and largely reducing the amount of time a speaker can communicate underwater without obtaining more air and repeating the entire process. This device uses a “sound-transferring diaphragm” to transfer the acoustic energy to the surrounding water. However, this diaphragm directly reflects the majority of the acoustic energy back into the mouth and thereby loses a large majority of the acoustic energy. This device also does not solve the problem of the noise made by the bubbles when expelling the air after the air chamber is full of air and during speech.

Alexander's U.S. Pat. No. 3,548,371 discloses a non-electronic underwater vocal communication device that can be used underwater without any other devices. This device requires the speaker to fill an air chamber with air before speaking, thus limiting the amount of air left in the divers lungs and largely reducing the amount of time a speaker can communicate underwater without repeating the entire process. Although one embodiment of this invention does not use a “sound projection diaphragm”, this embodiment has “more limited sound projection qualities.” In all of the embodiments of this invention, a large majority of the acoustic energy is directly reflected back into the speaker's mouth and the acoustic energy is therefore lost before enough reflections are made to adequately transmit the acoustic energy into the surrounding water.

### SUMMARY OF INVENTION

This invention is a breakthrough in underwater vocal communication devices. Although there has been a need for a device that overcomes the above-mentioned problems, no solutions have been available until now. This device solves the previously unrecognized need for an underwater communication device that is highly effective at transmitting acoustic energy into the surrounding water and yet is durable and easy to use. There are no underwater vocal communication devices available commonly or commercially that are, like this invention, economical, effective, and durable. This non-electronic device is also convenient in size and use. This device is amazingly effective at transmitting acoustic energy (sound) from the air inside the device to the surrounding water, with the sound heard being clear and loud, making underwater vocal communication more practical then it has ever been. This is a stand-alone device that does not require the use of any other device, apparatus, or equipment to work effectively. This device can be used to talk underwater without having to stay close to the surface. This device can be used underwater without the need to fill the device with air above the surface of the water. This device automatically replaces the water in the device with air as the user of the device, who will be referred to as the speaker, talks and exhales air. This device allows the speaker to begin speaking after exhaling a very small portion of air instead of having to fill an air compartment with air before speaking. This device does not require the speaker to hold anything in the speaker's mouth, thus speech is not impaired or muffled. Unlike balloon made of synthetic or natural rubber that can easily get punctured or worn out, this device does not have any parts that need to be constantly replaced. This device is very durable in all its preferred embodiments. This device expels excess air in small and relatively quiet bubbles. This device is rugged with no moving parts. Because of the simplicity of this device the device can be manufactured at low cost so as to be available to a large portion of the market. This device is easy to use. This device can be used without any above water preparation. This device will not be hard to submerse because the air used in the device is exhaled from the speaker and no additional air has to be submersed. This device is convenient in size and weight, not being bulky, heavy, or cumbersome to carry or use above or below the surface of the water. There has long been a need for an underwater vocal communication device that solves the previously mentioned problems, but until now none have been available.

This device is typically constructed of a plastic or other material that has acoustic impedance as close as possible to the acoustic impedance of water. The mouthpiece is built typically in the shape of a funnel or tube going downward, so that water is immediately expelled from around the mouth as soon as a small amount of air enters the device. The orientation of the mouthpiece allows the person using the device, here referred to as the speaker, to begin speaking as soon as a small area of the mouthpiece is filled with air instead of having to fill a large air chamber entirely with air before speaking. Underneath the mouthpiece is an air chamber. This air chamber can be made of almost any shape and can contain baffles or tubes going through the air chamber as long as the air chamber is shaped to substantially minimize the amount of acoustic energy being reflected back into the speaker's mouth. This device is amazingly effective at transmitting acoustic energy from the air inside the device to the surrounding water. This device is so effective because this device does not rely on a singular reflection of acoustic energy on an acoustic diaphragm or its equivalent, but instead the device is shaped to reflect the majority of the acoustic energy numerous times inside the device. At the bottom of the air chamber, typically in a convex shape, the air chamber will have a venting area made of small perforations that will allow small bubbles to escape.

Accordingly, it is an object of the present invention to provide a device for communicating underwater that: 1)is inexpensive,2)is non-electronic,3)is not limited to use near the water surface,4)is effective at reducing the disruptive sound of air bubbles escaping the device,5)is highly effective at transmitting acoustic energy to the surrounding water,6)is not fragile,7)is convenient in size and use,8)can be used underwater immediately without any planning or preparation,9)does not require a mouthpiece to be held in the mouth,10)does not require the device to be filled with air above the surface before submersing, 11)does not have moving parts or any parts that easily wear-out or need to be replaced.

Further objects and advantages will become apparent from a consideration of the drawings and following description.

### BRIEF DESCRIPTION OF DRAWINGS

FIG. 1A is an enlarged side view of an especially preferred embodiment of this invention being used.

FIG. 1B is a front view of the device shown in FIG. 1A.

FIG. 1C is a top view of the device shown in FIG. 1A.

FIG. 1D is a perspective, enlarged exploded sectional view taken along line 1D-1D of the device shown in FIG. 1C.

FIG. 2A is a side view of another preferred embodiment the device.

FIG. 2B is a bottom view of the device shown in FIG. 2A.

FIG. 2C is a sectional side view taken along line 2C-2C of the device shown in FIG. 2B.

FIG. 3 is a side view of another preferred embodiment the device.

FIG. 4 is a side view of another preferred embodiment the device.

FIG. 5 is a side view of another preferred embodiment the device.

FIG. 6A is a side view of another preferred embodiment the device.

FIG. 6B is a close-up exploded sectional view of a venting area for the preferred embodiment the device shown in FIG. 6A.

FIG. 7A is a side view of another preferred embodiment the device.

FIG. 7B is a close-up exploded sectional view of a venting area for the preferred embodiment the device shown in FIG. 7A.

FIG. 8 is a side view of another preferred embodiment the device.

FIG. 9 is a side view of another preferred embodiment the device.

FIG. 10 is a perspective view of a clip used in FIG. 11 and FIG. 12.

FIG. 11 is a side view of another preferred embodiment the device.

FIG. 12 is a side view of another preferred embodiment the device.

### DETAILED DESCRIPTION

The preferred embodiments of this invention typically use, among other principles, a principle of acoustic impedance. This is the principle that the better two materials match acoustic impedances, the better the acoustic energy, or sound, will be transmitted between the two materials. The acoustic impedance of materials is commonly measured in rayls (MKS is used here, but a Rayl can also refer to a corresponding CGS unit.) The acoustic impedance (in rayls MKS) is found by multiplying the density (kilograms per meters³) of a material by the velocity (meters per second) sound travels through the material. An average acoustic impedance of fresh water is 1.48×10⁶ rayls, and for saltwater 1.54×10 ⁶ (the actual acoustic impedance depends on the temperature and salinity of the water.)There is a large difference between the acoustic impedances of the device (matching the acoustic impedance of the water) and the air (415 rayls at standard atmospheric pressure and at 20° Celsius.) Because of the difference between the acoustic impedances only a small percent of the acoustic energy is transmitted through the device each time the acoustic energy hits the device. In order to transmit as much of the acoustic energy as possible from the speaker through the device and into the surrounding water, it is necessary to bounce the acoustic energy as many times as possible in the device. This is because the more times the acoustic energy is reflected inside the device, the more acoustic energy is transmitted into the surrounding water. So to increase the amount of the acoustic energy transmitted out of the device, increase the amount of times the acoustic energy is reflected on the surface of the device and on the surface of the water inside the device. To increase the amount of times the acoustic energy is reflected inside the device all that is necessary is to make the device in such a way that only a minimal amount of the acoustic energy is reflected back into the mouth.

This device is typically constructed of a plastic, silicone, rubber, or other material that has acoustic impedance as close as possible to the acoustic impedance of water. The acoustic impedance of the material used to construct the underwater vocal communication device should be as close as possible to 1.48×10⁶ rayls for fresh water use, and 1.54×10⁶ rayls for saltwater use. However, since the temperature of the water changes the acoustic impedance of the water, the device can be constructed of materials of varying acoustic impedances for different climates.

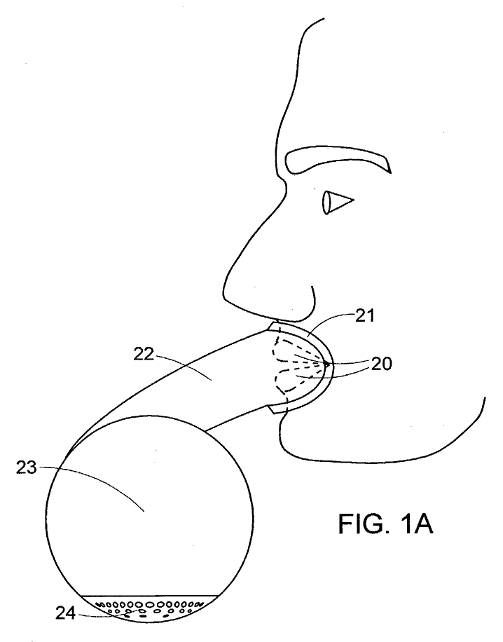

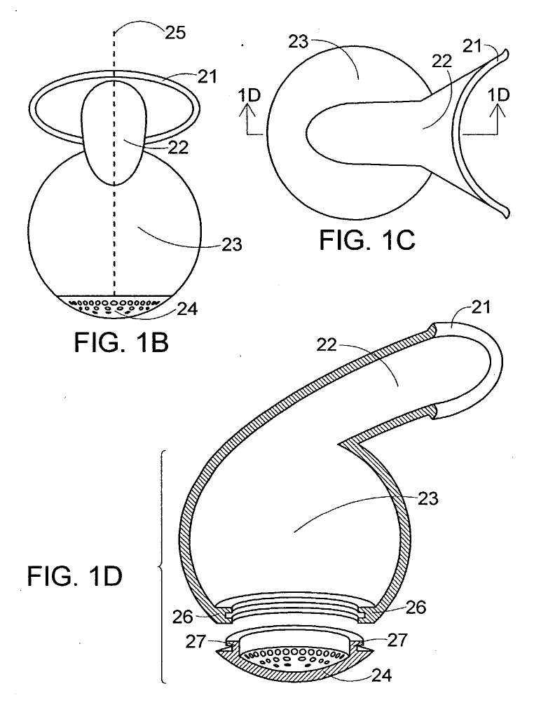

An especially preferred embodiment of this invention is shown in FIG. 1A-1D. This device is typically constructed of a rigid material, usually plastic, that can hold its shape underwater and is waterproof. A mouthpiece 22 is typically 2 to 20 centimeters in length and has a large end (referred to as seal 21) and a small end (not enumerated in the drawings because of obviousness.) The mouthpiece 22 at the seal 21 is large enough to surround the speaker's mouth 20. The seal 21 of the mouthpiece 22 is rounded and flaring outwards to make the seal 21 as comfortable and airtight as possible. The seal 21 can be constructed of the same material as the mouthpiece 22, or the seal 21 can be constructed of a more pliant material such as soft plastic, rubber, or foam for the comfort of the speaker. Another option is to construct the seal 21 of the same material as the mouthpiece 22 and attach a smaller layer (not shown) of pliant material such as soft plastic, rubber, or foam to the seal 21 where the seal 21 will come in contact with the skin surrounding the speaker's mouth 20. The seal 21 between the device and the speaker is to be airtight to avoid the escape of large and noisy air bubbles. The mouthpiece 22 is typically built in the shape of a funnel or tube going downward so that water is immediately expelled from around the mouth as soon as a small amount of air enters the device. The mouthpiece 22 directs the air and acoustic energy from the large end at the speaker's mouth 20 to the small end at an air chamber 23. The mouthpiece 22 is shaped to keep the majority of the acoustic energy from being reflected back into the speaker's mouth 20. This air chamber 23 is the shape of a sphere to facilitate multiple reflections of the acoustic energy off the walls of the air chamber 23. Because of the shape of the air chamber 23 a majority of the speaker's voice is transmitted into the surrounding water. This preferred embodiment is shown in FIG. 1D with a venting area 24, formed as a convex disk attached to the air chamber 23. This venting area 24 has small perforations between the sizes of approximately 1 to 100 square millimeters within the venting area 24. These small perforations within the venting area 24 are small enough that air is expelled from the device in small and relatively quiet bubbles. This venting area 24 is shown with the perforations in the shape of circles cut toward the center of the air chamber 23. This venting area 24 can alternatively have perforations in the shape of slots or other shapes cut out of it, as long as these perforations only allow the air to come out in small and relatively quiet bubbles. This venting area 24 is shaped with a male part 27 around the top rim of the venting area 24. The male part 27 interconnects with a female part 26 of the air chamber 23. The venting area 24 is attached to the air chamber 23 in such a way as to not create an area for air to collect and reform into larger bubbles. Instead of using the male part 27 and the female part 26 the venting area 24 and the air chamber 23 can alternatively be bonded together using any method that is permanent and airtight.

The especially preferred embodiment of this invention shown in FIG. 1A-1D, if made of a plastic, can be constructed using any conventional molding technique, such as injection molding. If the device is built with most molding methods it is possible to build the device in 3 pieces, with the air chamber 23, the mouthpiece 22, and the seal 21 being split along a line 25, and the third piece being the venting area 24. The perforations in the venting area 24 can be formed in the mold or the perforations can be bored out afterwards.

By building the device in segments and then bonding the segments together, all embodiments of this invention, if made of plastic, can be built with injection molding or equivalent methods. The embodiments of this invention can also be built with slush molding, rotational molding, or other equivalent methods as one piece or, if suitable, in a few relatively larger parts to be bonded together. It is also possible to use different molding techniques for separate parts of the invention. All of the embodiments of this invention can be made with existing manufacturing techniques.

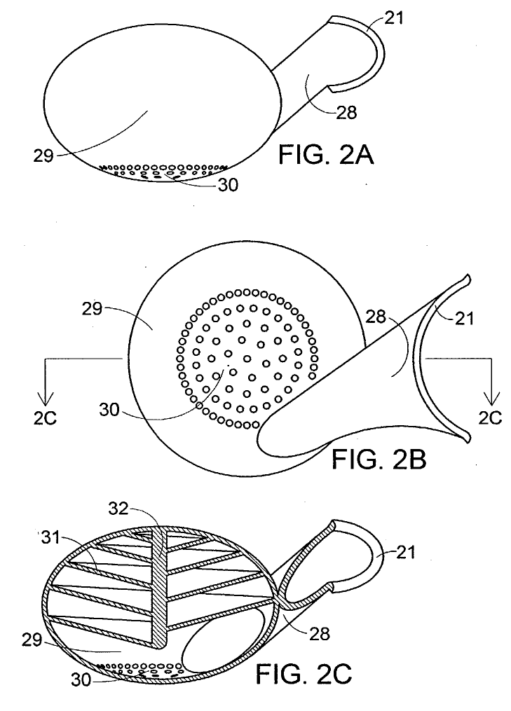

FIGS. 2A, 2B, and 2C show another preferred embodiment of the invention. This embodiment of the invention only has a few alterations to the especially preferred embodiment of this invention shown in FIG. 1A-1D. This invention is constructed with small perforations in an air chamber 29 making up a venting area 30. The air chamber 29 is spheroid shaped, or more specifically, is elliptically shaped. This preferred embodiment of the invention is shown with a baffle 31 rotating around a stem 32 toward the bottom of the air chamber. Although the stem 32 is shown stopping short of the bottom of the air chamber 29, the stem 32 alternatively can be extended down to or connect to the bottom of the air chamber 29 at the venting area 30. Although the baffle 31 is shown stopping short of the bottom of the air chamber 29, the baffle 31 can alternatively extend all the way to the bottom of the air chamber 29. The baffle 31 is shown tilted with the outside of the baffle 31 being higher than the inside. The angle of the baffle 31 helps the water to drain out of the air chamber 29 even if the device is not level. The angle of the baffle 31 also keeps the outside wall of the air chamber 29 free of water so that the acoustic energy is directed to the outside wall of the air chamber 29 and directly into the surrounding water. The baffle 31 could also be tilted the opposite direction or not be tilted at all. A benefit of this embodiment of the invention is that, with the mouthpiece 28 entering toward the bottom of the air chamber 29, the air chamber 29 can be either filled with air above water or left full of air between uses; therefore after the speaker fills the mouthpiece 28 with air underwater, the entire air chamber 29 can be used right away. Alternatively, the device can be constructed with the mouthpiece 28 entering the top of the air chamber 29 and with the spirals of the baffle 31 farther apart from each other at the top of the air chamber 29 and gradually getting closer together as the baffle 31 rotates downward to the venting area 30.

FIG. 3 shows that a preferred embodiment of the invention can be made with a mouthpiece 33 going into a very compact air chamber 34. The air chamber 34 is shaped like a reversed horn to facilitate multiple reflections of the acoustic energy. With the air chamber 34 being so compact the device is very convenient to carry around, both above and below water. This embodiment of the invention is also more convenient to carry around for occasional use. A venting area 35 is shown to be located at approximately the center of the air chamber 34. Alternatively the venting area 35 could be closer to the mouthpiece 33 or closer to the opposite end of the air chamber 34; however, the air chamber 34 has to be shaped so that the venting area 35 is located at the lowest part of the air chamber 34. This device can also be made with a rounded cap (not shown) at the end of the air chamber 34, in order to make the device safer (more blunt) and to make the end of the device stronger.

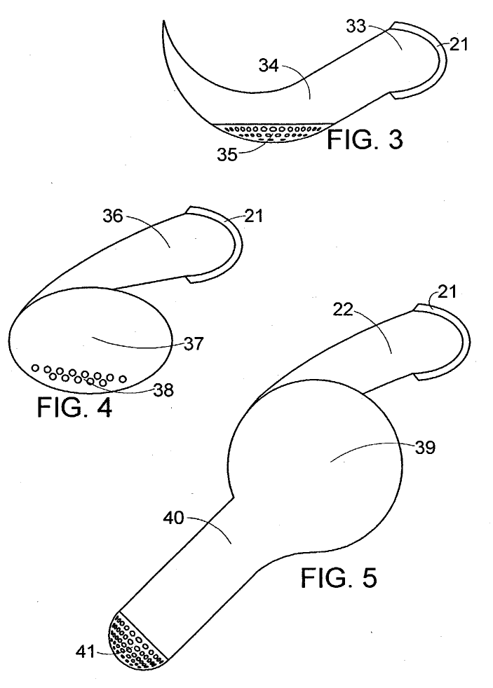

The preferred embodiment of the invention shown FIG. 4 shows that the device shown in FIG. 1A-1D can be made more compact. An air chamber 37 is smaller and more elliptical to make the device more convenient to carry around both above and below water. This embodiment of the invention is also more convenient to carry around for occasional use. In FIG. 1A-1D the venting area 24 is shown to be level with the approximate angle the device will be used at; whereas, in FIG. 4, the venting area 38 is instead angled with the perforations farther from the speaker relatively higher to move the majority of the air bubbles farther from the face. This venting area 38 also shows the perforations going directly from one side of the air chamber 37 to the other side of the air chamber 37, which has the advantage of making the perforations less complicated to build in the mold. The mouthpiece 36 tapers down to a smaller size at the conjunction with the air chamber 37. Because the mouthpiece 36 is so small at the small end it reduces the amount of the acoustic energy that is reflected back into the speaker's mouth 20 from the air chamber 37.

FIG. 5 shows another preferred embodiment of this invention. This embodiment of the invention is only slightly different then the especially preferred embodiment of this invention shown in FIG. 1A-1D. In this embodiment an air chamber 39 is altered to include a handle 40. The handle 40 makes holding the device easier and also extends a venting area 41 farther away from the face and, in so doing, moves the air bubbles farther away from the face.

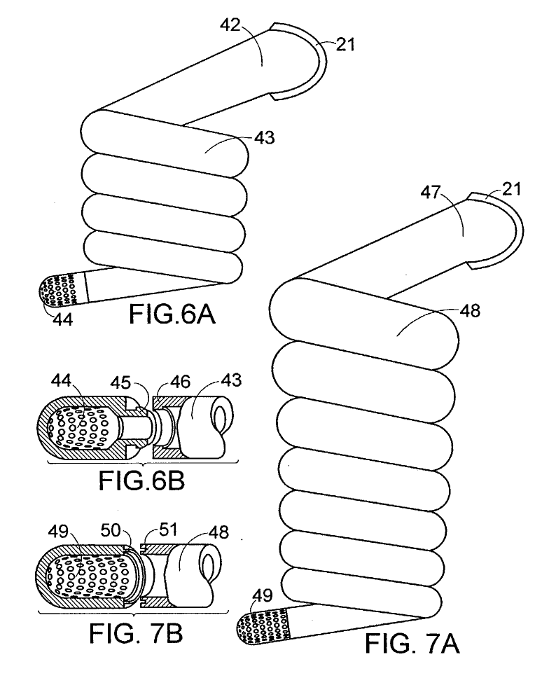

Another preferred embodiment of this invention is shown in FIGS. 6A and 6B. In this embodiment of the invention a mouthpiece 42 is essentially the same as the mouthpiece 22 shown in FIG. 1A-1D, however the mouthpiece 42 connects into a differently shaped air chamber 43. In this embodiment of the invention the air chamber 43 is shaped as a tube going in a circle spiraling downward forming a helix. The air chamber 43 is shaped in a gradually narrowing tube that gets smaller as the tube goes down toward a venting area 44. The air chamber 43 is relatively small in this embodiment for the convenience of use, making the device easier to carry above and below the water surface. The venting area 44 is constructed with the perforations in the venting area 44 in rows perpendicular to the tube of the air chamber 43. This venting area 44 can be constructed of the same material as the air chamber 43, or instead can be made of another material. This device is constructed so that once a male part 45 is inside a female part 46 the venting area 44 is held in place by the part 45 interlocking with the female part 46. Alternatively, the venting area 44 and the air chamber 43 can be bonded together using any method that is permanent and airtight.

The preferred embodiment of the invention shown in FIG. 7A is identical to the embodiment shown in FIG. 6A with the exception of an altered venting area 49, a more gradually tapering mouthpiece 47, and a longer and larger air chamber 48. The air chamber 48 in this embodiment gradually narrows as the air chamber 48 spirals down from the mouthpiece 47 toward the venting area 49. The air chamber 48 can be made large enough to hold all the air stored in the speaker's lungs. A purpose of this embodiment is to increase the amount of time a speaker can communicate with a single breath of air. Because of the size of the air chamber 48, the speaker can after talking into the device, inhale the previously exhaled and now trapped air, and then talk again. The venting area 49 can be constructed of the same material as the air chamber 48, or instead can be made of another rigid material. This venting area 49 is to be bonded to the air chamber 48. A male part 50 of the venting area 49 is to be fitted into a female part 51 of the air chamber 48. The venting area 49 is then bonded to the air chamber 48 with any bonding agent that will endure the underwater environment and will permanently hold these two parts together. Alternatively, the venting area 49 and the air chamber 48 can be bonded together using any method that is permanent and airtight.

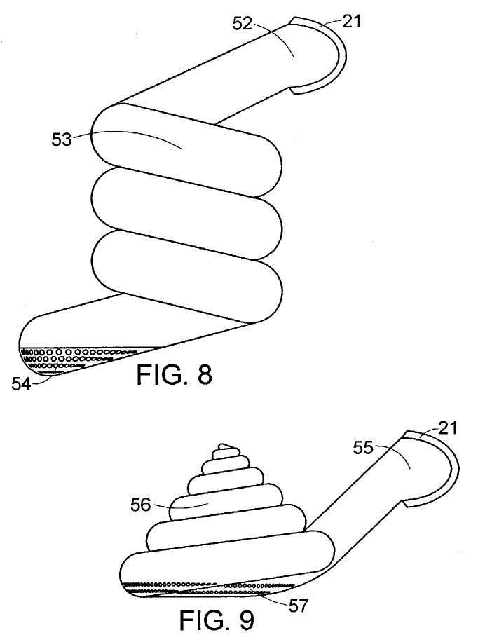

FIG. 8 shows an alteration to the preferred embodiment of the invention shown in FIGS. 6A and 6B, this embodiment having an air chamber 53 shaped as a tube that stays the same diameter as the air chamber 53 spirals down from a mouthpiece 52 toward a venting area 54. The venting area 54 is constructed as shown with the top of the air chamber 53 being approximately level during use.

The preferred embodiment of the invention shown in FIG. 9 is another variation from the preferred embodiment of the invention shown in FIGS. 6A and 6B. An air chamber 56 is shaped as a tube that gradually tapers as the air chamber 56 spirals upward in a shell like or turbinate shape. With the air chamber 56 spiraling upward a venting area 57 is located at the bottom of the air chamber 56. A benefit of this embodiment of the invention is that with a mouthpiece 55 entering toward the bottom of the air chamber 56, the air chamber 56 can be either filled with air above water or left full of air between uses, and after the speaker fills the mouthpiece 55 with air underwater, the entire air chamber 56 can be used immediately.

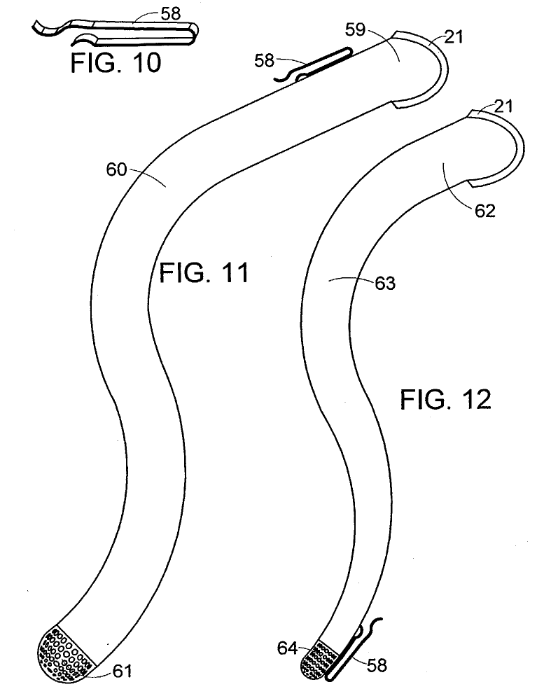

FIG. 10 shows a clip 58 that may be used to carry any of the embodiments of this invention. The clip 58 may be made out of metal, plastic, or any material that will hold its shape when the device is carried by the clip 58 and is also sufficiently durable to endure repetitive use.

FIG. 11 shows another preferred embodiment of the invention. In this embodiment of the invention an air chamber 60 is constructed of a material that is flexible. The air chamber 60 is a flexible tube of constant width with one end attached to a mouthpiece 59 and a second end attached to a venting area 61. The mouthpiece 59 and the venting area 67 can be constructed out the same material as the air chamber 60 or of a separate rigid or flexible material. If the mouthpiece 59 and the venting area 67 are constructed separate from the air chamber 60, the two sides can be bonded together in any manner that permanently seals the two parts together. If the venting area 61 is made of the same material as the air chamber 60, then the mouthpiece 59 can be made thicker to hold its shape if necessary. The flexible tube of the air chamber 60 is typically of a length between 0.1 to 1 meter long depending on the desired use, longer for increased volume and range, shorter for the convenience of carrying a smaller device. This embodiment of the invention is shown with the clip 58 attached to the device. Although this embodiment shows the clip 58 being used to carry the device, other fastening mechanisms can be used instead, such as a hook and loop fastener (not shown.) Instead of being attached directly to the device, the clip 58 can alternatively be attached to the device by a cord.

The preferred embodiment of the invention shown in FIG. 12 is very similar to the embodiment of the invention shown in FIG. 10 with the exception of an altered air chamber 63 and the placement of the clip 58. The air chamber 63 uses a tube that is gradually reduced in diameter as the tube goes from a mouthpiece 62 to a venting area 64. The clip 58 is shown attached to the device close to the venting area 64. An advantage to the clip 58 positioning is that the device can be easily grabbed and used without worrying about unfastening and refastening the device because the device can remain fastened to the speaker even during use. Another benefit to this clip 58 positioning is that only one hand is needed to use the device.

Swimmers, snorkelers, and divers can easily use all of the preferred embodiments of the invention. One reason this invention is so easy to use is that none of the embodiments of the invention require the speaker to learn a new or altered way of speaking.

The preferred embodiment of this invention shown in FIG. 1A-1D can be operated to communicate underwater in the following way. First the speaker goes underwater (or is already underwater in some cases, such as in scuba diving.) Then the device is coupled to the speaker. The speaker does this by using one hand to hold the device in an airtight relationship with the skin surrounding the mouth 20. Then the speaker breathes enough air into the mouthpiece 22 to remove the water from around the mouth inside the mouthpiece 22; alternatively the speaker can skip this step and just start talking. Next the speaker talks normally just like the speaker would talk above water. As the air chamber 23 is filled with air less of the acoustic energy is reflected back into the mouth 20, and correspondingly a larger portion of the acoustic energy is transmitted out of the device. By speaking into the air chamber 23 the water inside the device is forced out of the device through the venting area 24. After the air chamber 23 is filled with air, excess air is expelled from the device in small and relatively quiet bubbles through the venting area 24. After the speaker is done talking or is in need of more air, the speaker removes the device from his mouth 20. Then after the speaker receives more air, the speaker is free to start the process over if more communication is desirable. Although vocal communication is the primary mode of communication, the speaker can also whistle into the device to get the attention of others or to increase the range from which the speaker can be heard. The embodiments of the invention shown in FIGS. 3, 4, 5, 6A, 6B, and 8 are operated in the same fashion as the device shown in FIG. 1A-1D.

The embodiment shown in FIGS. 2A, 2B, and 2C has one change to the method of operation described for FIG. 1A-1D. The air chamber 29 can be, but does not have to be, either filled with air above water or left full of air between uses, and after the speaker fills the mouthpiece 28 with air underwater, the entire air chamber 29 can be used immediately. This is advantageous because the speaker will be able to use the entire air chamber 29 sooner. Using the entire air chamber 29 is desirable because of its increased acoustic transmitting ability due to the increased number of reflections of the acoustic energy within the air chamber 29. The method of operation of the embodiment shown in FIG. 9 is also the same as the method of operation for the embodiment shown in FIGS. 2A, 2B, and 2C.

The change to the method of operation of the embodiment shown in FIGS. 7A and 7B compared to the embodiment shown in FIG. 1A-1D is that the speaker has the option of reusing the already exhaled air. In order to communicate for longer periods of time, the speaker first talks and at least partially fills the air chamber 48 with air. The speaker can tell the device is full of air when he sees air bubbles coming from the venting area 49. Then the speaker inhales some of the trapped air and stops inhaling before water reaches the speakers mouth. Then the speaker of the device begins talking again. The speaker should only reuse the same air a few times to keep from being endangered by the lack of oxygen present in the reused air.

The change to the method of operation of the embodiment shown in FIG. 11 compared to the embodiment shown in FIG. 1A-1D is that, if the air chamber 60 is over approximately 30 centimeters long, two hands are required to operate this embodiment. The venting area 67 should be held below the level of the mouthpiece 59 with one hand, while the other hand holds the seal 21 of the mouthpiece 59 against the skin surrounding the mouth 20 creating an airtight seal.

The change to the method of operation of the embodiment shown in FIG. 12 compared to the embodiment shown in FIG. 11 is that two hands are no longer required to operate this embodiment even if the air chamber 63 is over approximately 30 centimeters long. The venting area 64 can be held below the level of the mouthpiece 62 with the clip 58 or other fastening mechanism, while the other hand holds the mouthpiece 62 in an airtight relationship with the skin surrounding the mouth 20.

This invention is a breakthrough for simple, durable, and economical underwater vocal communication. This device is usable not only for the serious underwater enthusiast, but also as a toy.

While my above description contains many specificities, these should not be construed as limitations on the scope of the invention, but rather as an exemplification of a few preferred embodiments thereof. Many other variations are possible. The following will illustrate some of the possible variations within the scope of this invention. The device can be made in many different shapes that do not reflect the majority of the acoustic energy back into the speakers mouth, for example: 1) with the air chamber shaped in an oblate orb or rounded disc shape, with the mouthpiece coming into the air chamber at a angle so that the acoustic energy is not reflected back into the mouth, 2) with the air chamber shaped in a sea-shell or turbinate shape with the mouthpiece connecting into the top and the air chamber gradually getting smaller as the air chamber goes down toward the venting area, 3) with the air chamber shaped in a tubular helix shape with the mouthpiece connecting to the bottom of the helix of the air chamber, and with the venting area located at the bottom of the air chamber, 4) with the air chamber shaped in a long rigid tube going in any pattern where the majority of the water will still drain out of the device when the device is filled with air underwater, 5) with the air chamber above the mouthpiece and with the vent area in the tubular part of the mouthpiece, 6) with the air chamber made with a variety of tubes or baffles going through air chamber, 7) with the small end of the mouthpiece extending inside the air chamber to further limit the amount of acoustic energy reflected back into the mouth, 8) with a plurality of air chambers, with the chambers being organized serially (each one attached to the next) or in parallel with the mouthpiece going into the plurality of air chambers, or a combination of the two organizations. This invention can be designed to work with the speaker in a horizontal position by changing the angle the mouthpiece is attached to the face and then moving the venting area down to the bottom of the device when the device is in this horizontal position. This device can be made with a layer of congruent elastic material covering the venting area to cause the venting area to become a one-way valve, allowing air and water to escape but not return into the device. This device can also be made with the venting area consisting of perforations going up the side of the air chamber as long as the perforations are few enough and small enough to keep the air chamber mostly full of air while the speaker is talking. The mouthpiece can be simplified to a very short mouthpiece directly attached to the air chamber with the large and small ends of the mouthpiece very close together. This device can be constructed out of a material that does not match the acoustic impedance of the surrounding water, although this may lower the effective range and volume the speaker can be heard from. This device can also be made with several layers of different materials, for example with a more durable or a more colorful material on the outside of the device and a layer of another material on the inside (though the materials of the separate layers should be as close as possible to each others acoustic impedance or they may lower the volume of the speakers voice.) The preferred embodiments of the invention shown individually in FIGS. 1A-1D, 2A-,2C, 3, 4, 5, 6A-6B, 7A-7B, 8, 9, 11, and 12 often show several different variations to the preferred embodiments of the invention, but each of these variations can independently be applied to the other preferred embodiments of the invention. The size and shape of the air chamber is very adaptable because although the air chamber needs to reflect the acoustic energy multiple times to transmit the acoustic energy to the surrounding water, many shapes are capable of doing so. Because of the variability of the size and shape of the air chamber, as a toy the device is easily adaptable to different themes and for the serious underwater enthusiast can be customized to fit a large variety of needs.

It is clear to one skilled in the art that many deviations can be made to the preferred embodiment of this invention without departing from the scope and spirit of this invention. Accordingly the scope of this invention is to be limited only by the following claims.

What I claim as my invention is:

1. An underwater vocal communication device comprising:
a)an air chamber sufficiently shaped to minimize the amount of acoustic energy being directly reflected back into a speaker's mouth;
b)a mouthpiece to create a substantially airtight seal between said air chamber and the speaker;
c)a venting means for venting air and water from said air chamber, said venting means being located at approximately the lowest part of said air chamber;
whereby speaking into said device underwater through said mouthpiece acoustic energy is transmitted into the water surrounding said device and the exhaled air urges the water and air inside said device out through said vent area.

2. The device of claim 1 wherein said mouthpiece is further comprised of a substantially funnel shaped tube of approximately 2 to 20 centimeters in length with said mouthpiece tapering as said mouthpiece goes toward said air chamber.

3. The device of claim 1 wherein said air chamber is further comprised of a rigid material in a substantially spheroid shape.

4. The device of claim 1 wherein said air chamber is further comprised of a rigid material in a tubular shape formed into a substantially helix shape.

5. The device of claim 1 wherein said air chamber is further comprised of a rigid material in a tubular shape formed into a substantially turbinate shape.

6. The device of claim 1 wherein said air chamber is further comprised of a rigid material in a reversed horn shape.

7. The device of claim 1 wherein said air chamber is further comprised of a flexible material in a substantially tubular shape.

8. The device of claim 7 wherein said air chamber is further comprised of a substantially tubular shape between approximately 0.1 to 1 meter long that tapers as said air chamber goes from said mouthpiece toward said venting means.

9. The device of claim 7 wherein said air chamber is further comprised of a tubular shape between approximately 0.1 to 1 meter long that remains a constant diameter.

10. The device of claim 1 wherein said venting means is further comprised of perforations of approximately 1 to 100 square millimeters in area.

11. An underwater vocal communication device comprising:
a)An air chamber that is sufficiently shaped to substantially minimize the amount of acoustic energy being directly reflected back into a speaker's mouth;
b) A mouthpiece comprising a small end connecting to said air chamber and a large end being large enough to surround said speaker's mouth, said mouthpiece creating a substantially airtight seal between said device and the speaker while directing air and acoustic energy from said large end toward said small end and into said air chamber;
c)A vent area at the lowest part of said air chamber with perforations of approximately 1 to 100 square millimeters extending through said air chamber to allow an exchange of air and water from inside to outside of said air chamber.
Whereby when speaking into said mouthpiece underwater acoustic energy is transmitted through said air chamber into the surrounding water and the exhaled air forces the water and air inside said device out through said vent area.

12. The device of claim 11 wherein said air chamber is further comprised of a rigid material in a substantially spheroid shape with the same acoustic impedance as said surrounding water.

13. The device of claim 11 wherein said air chamber is further comprised of a rigid material in a tubular shape formed into a substantially helix shape, with said material having substantially the same acoustic impedance as said surrounding water.

14. The device of claim 11 wherein said air chamber is further comprised of a rigid material in a tubular shape formed into a substantially turbinate shape with said material having substantially the same acoustic impedance as said surrounding water.

15. The device of claim 11 wherein said air chamber is further comprised of a substantially tubular shape between approximately 0.1 to 1 meter long and remaining a constant diameter with one end attached to said mouthpiece and a second end attached to said venting means, said air chamber is further comprised of a flexible material with substantially the same acoustic impedance as said surrounding water.

16. The device of claim 11 wherein said air chamber is further comprised of a end attached to said mouthpiece and a second end attached to said venting means, said air chamber is further comprised of a flexible material with the same acoustic impedance as said surrounding water, said air chamber is further comprised of a substantially tubular shape between approximately 0.1 to 1 meter long that tapers as said air chamber goes toward said second end.

17. A method of communicating underwater through the use of an underwater vocal communication device, said device having an air chamber with a mouthpiece and a venting area, said method comprising:
a)forming a substantially airtight seal between said device and a speaker's mouth;
b)speaking into said device until said speaker wants more air or said speaker is done communicating;
c)after acquiring more air, repeating said method until said speaker is done communicating;
Whereby after going underwater and then speaking into said device acoustic energy is transmitted into the surrounding water and exhaled air forces the water inside said device out through said vent area, then said exhaled air is expelled in small and relatively quiet air bubbles.

18. The method of claim 17, further including another step, after said step of forming a substantially airtight seal, blowing into said device until air displaces the water inside said mouthpiece to below said speaker's mouth.

19. The method of claim 17, further including another step, after said step of speaking into said device, if more communication is desired by said speaker, inhaling a portion of previously exhaled air and again speaking into said device, repeating this step until said speaker is done communicating or until said speaker needs fresh air.
